(19) United States
(12) Patent Application Publication
(10) Pub. No.: US 2025/0343574 A1
(43) Pub. Date: Nov. 6, 2025

(54) ENHANCING RECONFIGURABLE INTELLIGENT SURFACE SECURITY WITH TIME OF FLIGHT BASED FULL PATH INTEGRITY VALIDATION

(71) Applicant: Dell Products L.P., Round Rock, TX (US)

(72) Inventors: Sheng Sun, Kanata (CA); Tejinder Singh, Manotick (CA); Raja Neogi, Portland, OR (US)

(21) Appl. No.: 18/656,412

(22) Filed: May 6, 2024

(51) Int. Cl. H04B 7/04; H04B 7/155; H04B 17/309

(52) U.S. Cl. CPC H04B 7/04013; H04B 7/15514; H04B 17/346

(57) ABSTRACT

The technology described herein is directed towards using time of flight data to validate path integrity of a wireless communications path between authorized entities, in which a reconfigurable intelligent surface is part of the signal path between a base station and a user equipment, and using signal strength data for evaluating whether the path is compromised. In one example, an eavesdropping entity can tap into part of the signals to and/or from a base station and user equipment via a reconfigurable intelligent surface. As part of monitoring for an eavesdropper, the path is validated based on the time of flight data, and the measured signal strength is evaluated with respect to the expected signal strength. A drop in the expected signal strength indicates a potential eavesdropper. In one implementation, generative adversarial network models are used in the monitoring of the signal path.

### BACKGROUND

Reconfigurable intelligent surfaces (alternatively referred to as intelligent reflective surfaces, or metasurfaces) are man-made thin reflective or refractive surfaces whose electromagnetic response can be electronically controlled. Reconfigurable intelligent surfaces are characterized by their two-dimensional arrays of electronically controllable reflecting elements that can dynamically manipulate electromagnetic waves by altering attributes such as phase, amplitude, and direction of the incoming signal.

Each metasurface typically is made up of (possibly up to) dozens, hundreds or thousands of unit-cells, and because the individual unit-cell can be controlled, reconfigurable intelligent surfaces can provide programmable and smart wireless environments. For example, one scenario is to use such a surface to intelligently reconfigure wireless communications. More particularly, objects in the path of a wireless signal, such as buildings and trees, can block wireless communication signals at higher frequencies, including millimeter-wave (mm-Wave) frequency bands (24.5 gigahertz, or GHz-52.6 GHz), and even higher. This can be overcome by installing a large number of base stations to provide coverage to otherwise blocked areas, but doing so would increase the infrastructure costs many times. Instead, a relatively inexpensive metasurface can be installed at various locations to reflect and/or refract higher frequency signals to otherwise blocked or weak coverage areas.

Physical security can be compromised in a mm-Wave communication system with reconfigurable intelligent surfaces. For example, an eavesdropper can tap into signals with respect to unauthorized receiving of the downlink beam to and/or uplink beam from a legitimate user equipment.

### BRIEF DESCRIPTION OF THE DRAWINGS

The technology described herein is illustrated by way of example and not limited in the accompanying figures in which like reference numerals indicate similar elements and in which:

FIG. 1 is a representation of an example secure communication setup using a reconfigurable intelligent surface in a communications path, including models for verifying path integrity, in accordance with various example embodiments and implementations of the subject disclosure.

FIG. 2 is a representation of an example attacking scenario in which an eavesdropper intercepts and redirects uplink and/or downlink communications in a communications path involving a reconfigurable intelligent surface, in accordance with various example embodiments and implementations of the subject disclosure.

FIG. 3A is a cross-sectional side view of an example unit cell design showing a stack and arrangement of fabricated layers of a unit cell of a reconfigurable intelligent surface, in accordance with various example embodiments and implementations of the subject disclosure.

FIG. 3B is a representation of an example portion of a reconfigurable delay detection network that can be coupled to a reconfigurable intelligent surface's cells, by which changes in signal strength can be detected, in accordance with various example embodiments and implementations of the subject disclosure.

FIG. 4A is a semi-transparent top view representation of an example unit cell having a receive (Rx) antenna and a variable tuning element, in accordance with various example embodiments and implementations of the subject disclosure.

FIG. 4B is a semi-transparent perspective view representation of an example unit cell having a receive (Rx) antenna and a variable tuning element, in accordance with various example embodiments and implementations of the subject disclosure.

FIG. 5 is a representation of an example reconfigurable delay detection network, along with a bottom view representation of an example unit cell, and with an enlarged example portion of the reconfigurable delay detection network, in accordance with various example embodiments and implementations of the subject disclosure.

FIG. 6 is a reconfigurable intelligent surface of 6×6 panels using individual 3×3 modules of unit cells (total 18×18 unit-cell elements), coupled to a receive (Rx) antenna, in accordance with various example embodiments and implementations of the subject disclosure.

FIG. 7 is a graphical representation of phase of a reflected signal around the operational frequency of 28 GHz, as varied with the change in capacitance of varactor, in accordance with various example embodiments and implementations of the subject disclosure.

FIG. 8 is a graphical representation of the magnitude of the reflected signal, and the magnitude of the signal coupled to a substrate integrated waveguide, for different varactor capacitances, in accordance with various example embodiments and implementations of the subject disclosure.

FIG. 9 is a flow diagram showing example operations related to monitoring the receive (Rx) antenna of a reconfigurable intelligent surface to determine if a signal path is compromised by a potential eavesdropper, in accordance with various example embodiments and implementations of the subject disclosure.

FIG. 10 is a representation of example models within network equipment and a user equipment (endpoint agent) that can be used to detect an invalid communications path indicative of the presence of an eavesdropper, in accordance with various example embodiments and implementations of the subject disclosure.

FIG. 11 is a flow diagram showing example operations related to time-of-flight-assisted path validation, in accordance with various example embodiments and implementations of the subject disclosure.

FIG. 12 is a flow diagram showing example operations related to determining whether a signal path is compromised by a potential eavesdropper based on evaluating current time of flight data with respect to a time of flight dataset, and evaluating current signal strength data with respect to expected beam signal strength data, in accordance with various example embodiments and implementations of the subject disclosure.

FIG. 13 is a flow diagram showing example operations related to determining whether an anomaly is present in a signal path based on expected time of flight data or expected signal strength data, in accordance with various example embodiments and implementations of the subject disclosure.

FIG. 14 is a flow diagram showing example operations related to outputting a notification indicative of a potential eavesdropper in response to determining that beam integrity is compromised, or the signal path is compromised, in accordance with various example embodiments and implementations of the subject disclosure.

### DETAILED DESCRIPTION

The technology described herein is generally directed towards verifying the integrity of a wireless communications path that includes a reconfigurable intelligent surface (also referred to as a tile), based on identifying any anomalies with respect to expected data. For example, the actual time of flight data versus previously measured time of flight data can be used to fingerprint the reconfigurable intelligent surface as the path identity and thereby verify the integrity of the communications path. Further, an anomaly in the expected versus actual amplitude received signal at the base station or a user equipment can be detected. This type of beam-based fingerprinting is facilitated by adding path-sensitive reconfigurable delay detection hardware (e.g., including multiple metal-insulator-metal capacitors) to a reconfigurable intelligent surface's hardware.

In one implementation, a receiving antenna is incorporated into or coupled to the reconfigurable intelligent surface, along with a reconfigurable delay detection network that monitors a signal for potential existence of a drop in expected signal strength. Such an amplitude drop can indicate a “tapping into the signal path” attack in which an eavesdropping entity listens in on the source (e.g., base station-originated or user equipment-originated) signal. By monitoring for such a signal strength drop, a notification of a potentially compromised signal path can be output (e.g., to the base station) for taking some mitigating action. The amplitude, phase and resonance frequency of a signal received at the receiver of the reconfigurable intelligent surface can be parameters for part of the bidirectional path integrity evaluation, as can the received signal strength information, and the signal-plus-interference-to noise ratio data as detected by the user equipment (endpoint agent). Time of flight data can be used as parameters for path validation, e.g., to ensure that the path has not been altered as part of an attack.

In one implementation, artificial intelligence/machine learning models can be used for automatic anomaly detection, e.g., by determining and evaluating the relative strengths of possible anomalies, e.g., for random samples in the path. Generative adversarial networks can be employed by an endpoint agent (e.g., at the user equipment) and at a tile controller coupled to the reconfigurable intelligent surface and the base station.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

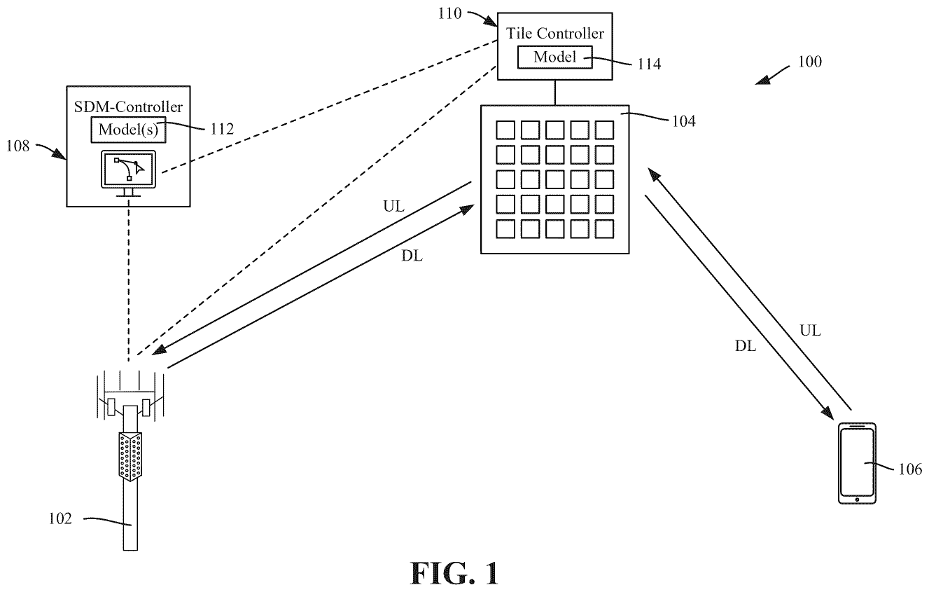

FIG. 1 is a conceptual depiction of an example system 100 including a base station 102 that communicates downlink (DL) and uplink (UL) signal transmissions, via a reconfigurable intelligent surface 104, with a user equipment 106. Although not explicitly shown in FIG. 1, consider that the reconfigurable intelligent surface 104 is needed to avoid an obstacle between the base station 102 and the user equipment 106.

The base station 102 is coupled to a software defined metasurface (SDM) controller 108 that manages tile controllers, including a tile controller 110 coupled to the reconfigurable intelligent surface 104. Note that a tile controller may manage multiple reconfigurable intelligent surfaces, e.g., generally located close to one another, such as mounted on or deployed within a building or close group of buildings.

As will be understood, in one implementation, the defined metasurface controller 108 includes a group of artificial intelligence (AI/ML) models 112, and the tile controller 110 includes a model 114 (e.g., a generative adversarial network model), that work together to verify the integrity of the communications path between the base station 102 and the UE 106 via the reconfigurable intelligent surface 104. In one implementation, the group of AI/ML models 112 includes a deep reinforcement learning model, a large language model (LLM) and a generative adversarial network model.

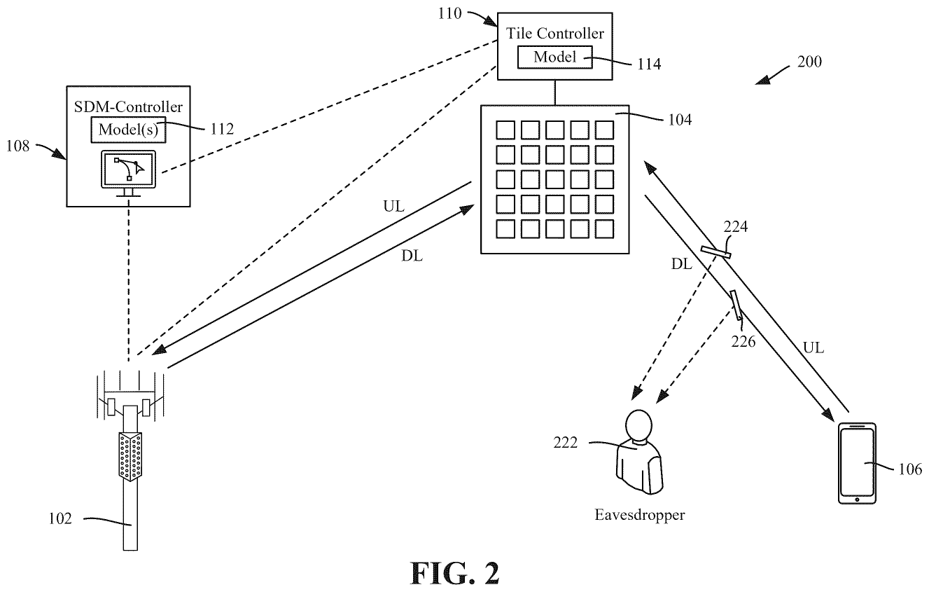

FIG. 2 is a conceptual depiction of a later instance 200 of the example system (i.e., system 100 of FIG. 1). In FIG. 2, an eavesdropping entity (eavesdropper) 222 has inserted one or more reflective elements (two example reflective elements 224 and 226 are shown) into the intended communications path to tap into the uplink (UL) and/or downlink (DL) communication signals. Note that the eavesdropper 222 may tap into only the uplink or downlink signal, but in this example receives both. Further note that the eavesdropper may not be a person, but can be a recording device, a device configured to detect certain data (e.g., words or phrases), and so on.

In this attacking scenario, the eavesdropper couples a small portion of the energy from the original communication link by introducing another reflector or metasurface. Because some of the energy is coupled, this corresponds to a drop in amplitude in the signal received by the user equipment from the base station, that is, changes the beam fingerprint. This also can result in a time of flight change with respect to an expected time of flight from the sender to the receiver via the reconfigurable intelligent surface.

The received amplitude can be used to extract information about the authenticity of the signal; an advanced metasurface as described herein provides a layer of authentication to check the beam fingerprint at hardware level, offering a methodology of integrity validation over communication paths that use a reconfigurable intelligent surface for secure communication links. Further, the expected time of flight can be learned as a path fingerprint for the reconfigurable intelligent surface, validating that the path has not been altered.

Thus, described herein is detecting such an attack scenario, based on the base station or user equipment not receiving the expected signal strength over a validated path, and/or because the path integrity cannot be validated. To this end, the reconfigurable intelligent surface is coupled to a receive (Rx) antenna, (or multiple Rx antennas), and contains detection circuitry in the form of a reconfigurable delay detection network that detects any S₁₁ and/or S₂₁ amplitude changes from the expected beam fingerprint over the time-of-flight validated path/reconfigurable intelligent surface. The reconfigurable delay detection network can be tuned with respect to selecting a delay that changes the frequency shift, leading to the detection of security risks, e.g., and eavesdropper in the path.

In general, a reconfigurable intelligent surface is typically made from adaptable two-dimensional element arrays, also referred to as an array of unit cells, with each element/unit cell being able to toggle between multiple reflection phases. The precision of the reflected field patterns depends on the size of the aperture and the count of reflective elements, which can be suited to varying communication contexts and settings.

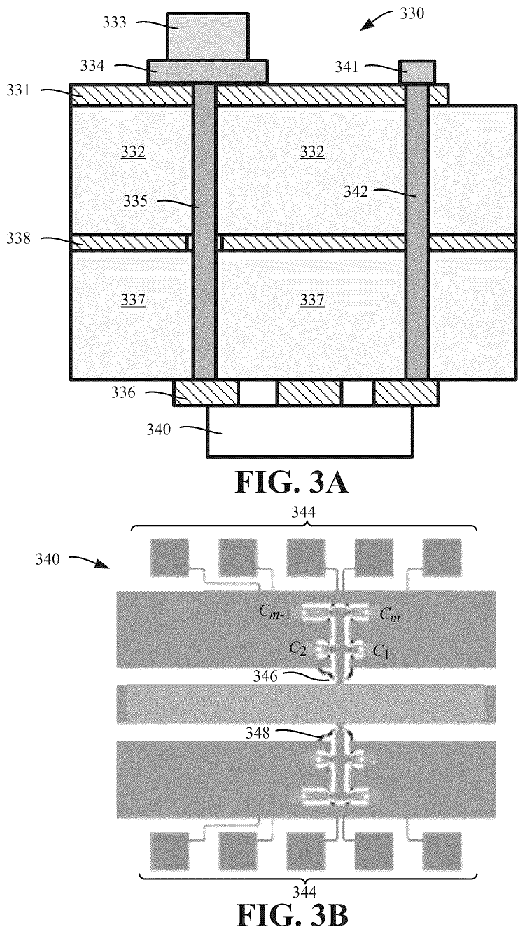

FIG. 3A shows a cross-sectional side view of a nonlimiting fabrication layer stack and arrangement of a unit cell 330. A top metallization layer 331 is patterned on a first substrate layer 332. The unit cells/elements are designed on each cell's metallization layer 331. In one example implementation, a surface mounted device (SMD) tunable device 333 (e.g., varactor/capacitor PIN diode) can be soldered on top of SMD pads 334 atop the metallization layer 331, with a via 335 (e.g., for voltage control connections of the tunable device 333) to a bottom metallization layer 336 (and control pads) that couples to a microcontroller that determines the voltage to the tunable device 333.

The underside of the first substrate layer 332 is separated from a second substrate layer 337 by a metal plane 338 acting as RF ground. Below the underside of the second substrate layer 337 is the bottom metallization layer 336 which is patterned to form the DC biasing and control circuitry. To ensure seamless interconnection across the multi-layered stack, the via 335 is strategically positioned. For instance, the tunable device 333 (e.g., varactor) is linked to two vias (only one via 335 is represented in the example of FIG. 3A; another via, not explicitly shown, connects the varactor's negative terminal to the ground plane 338, while the other via 335 links its positive terminal to the biasing on the bottom metal layer 336.

Also shown in FIG. 3A is a reconfigurable delay detection network 340 as described herein, which in general operates to detect any beam changes at the unit cell 330, which has a relationship with the amplitude/signal strength of a received signal. As described herein, changes in the S₁₁ and S₂₁ amplitudes from their expected magnitudes indicate the presence of a potential eavesdropping entity.

The reconfigurable delay detection network 340 is coupled to the signal received at a receive (Rx) antenna 341 through a via 342. Note that not every unit cell needs a receive antenna. For example, there can be one receive antenna per subgroup of unit cells, e.g., a 9×9 subarray module. Still further, only unit cells (e.g., a row or column of adjacent unit cells) that are used for detection need to be coupled to a reconfigurable delay detection network, which in turn is coupled to a receive antenna.

FIG. 3B shows a portion of one nonlimiting example implementation of reconfigurable delay detection network circuitry 340. In FIG. 3B, control pads 344 couple the RF signal to capacitors, e.g., capacitors C₁-Cₘ, which facilitate changing the overall capacitance to investigate the delay of an RF signal received (via the Rx antenna 341) at the corresponding unit cell. Loading switches 346 and 348 can be controlled to change the total capacitance, e.g., by coupling different numbers and/or capacitors having different capacitance values together in various combinations.

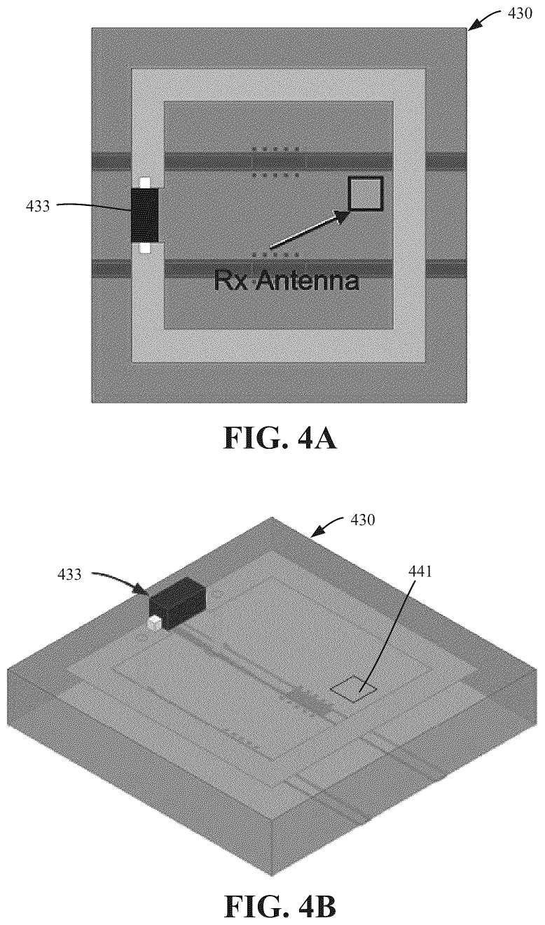

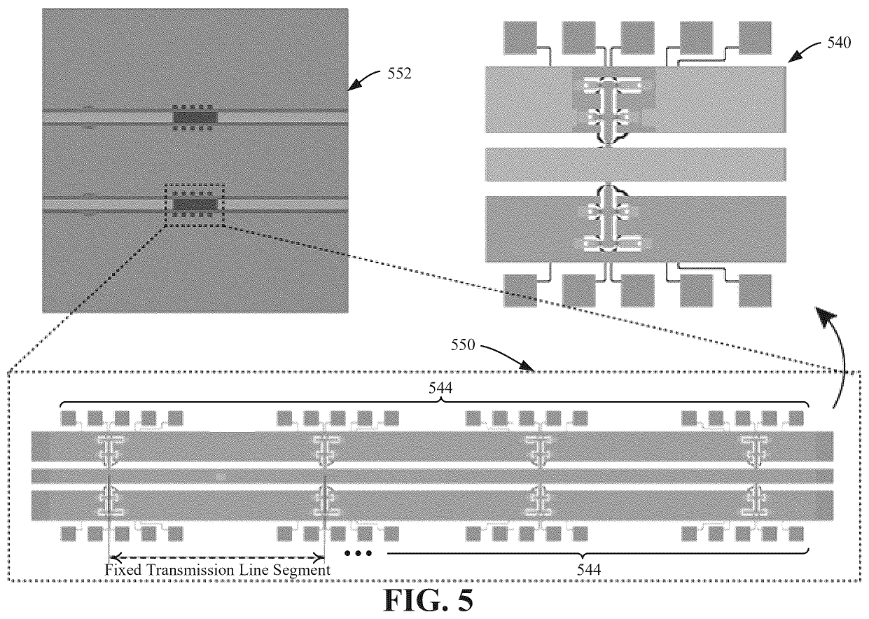

FIGS. 4A and 4B show a top view representation and a perspective view representation, respectively, of an example unit cell 430 having a receive (Rx) antenna 441 and a variable tuning element 433. As described with reference to FIG. 3A, the Rx antenna 441 is coupled to the reconfigurable delay detection network (FIG. 5), which can modify delay values corresponding to phases (S₂₁ signal)/capacitances/complex impedance.

FIG. 5 is a representation of an example reconfigurable delay detection network 550, along with a bottom view representation 552 of an example unit cell and of an enlarged example portion 540 of the reconfigurable delay detection network 550. Any signal that is flowing (e.g., from left to right) in the RF control pads 544, is used to detect any impedance mismatch that is occurring, that is, the capacitance/complex impedance is different on the well-known Smith chart for the S₂₁ signal.

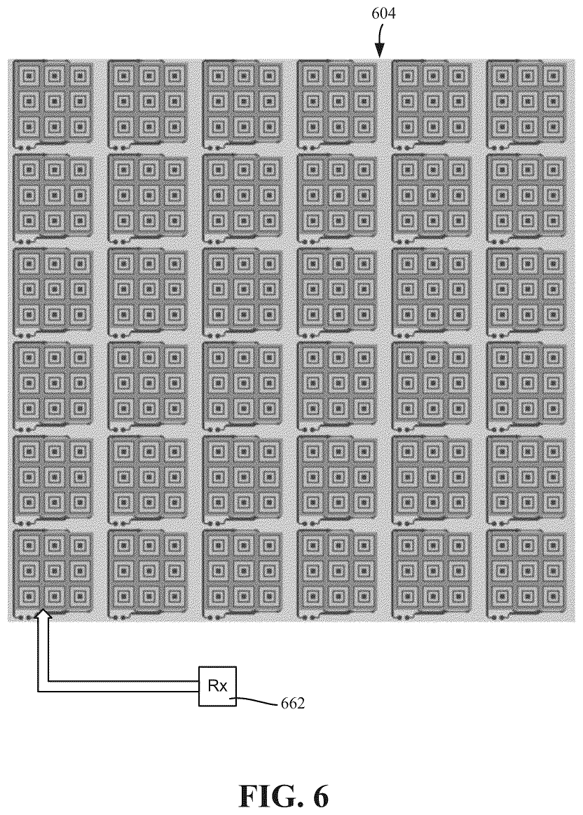

FIG. 6 shows a reconfigurable intelligent surface 604 in which the unit cells are arranged as 3×3 subarrays in modules, or subpanels in a 6×6 array, forming a total of 18×18 unit-cell elements. There is no requirement that unit cells be arranged as subarrays, or modules, however certain situations benefit from having such modules, e.g., a selected number of such modules can be interconnected as needed for a given scenario. As set forth herein, at least one receive Rx antenna 662 is associated with the reconfigurable intelligent surface 604 and coupled to corresponding reconfigurable delay detection network circuitry.

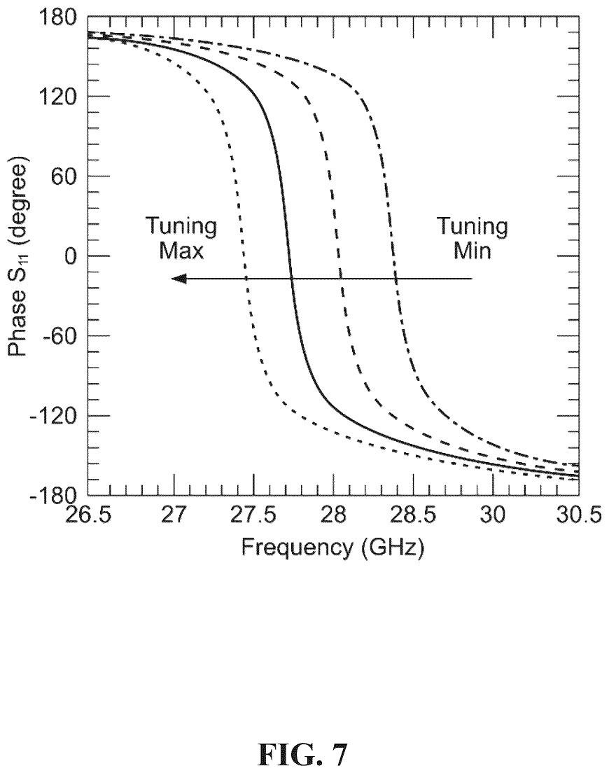

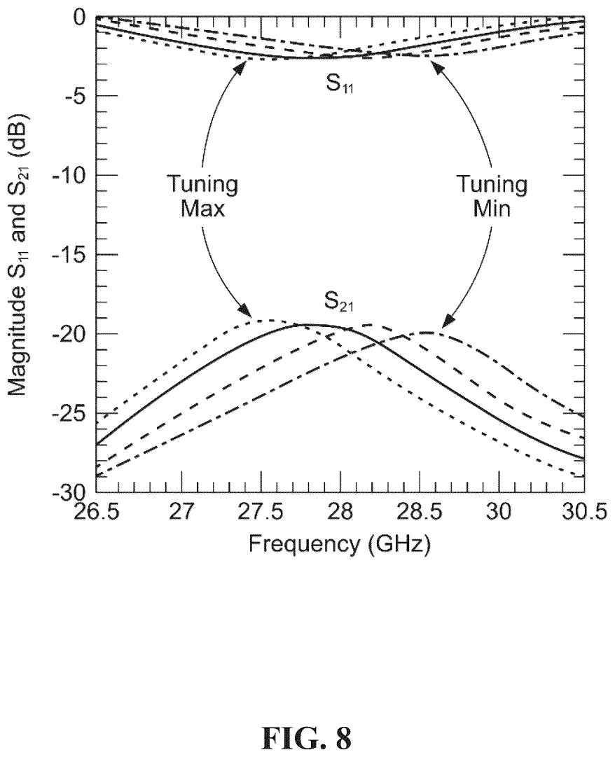

FIG. 7 shows the phase of a reflected signal (S₁₁) around the operational frequency of 28 GHz, with the change in capacitance of a varactor from a tuning minimum to a tuning maximum based on varying bias voltage. FIG. 8 graphically shows the magnitude of the transmitted signal (S₂₁) and the reflected signal (S₁₁).

In FIG. 8, the Sun magnitude with varying capacitance tuning highlights the reflection from the reconfigurable intelligent surface element, while the S₂₁ magnitude indicates the signal's interaction with the receive antenna(s) of the reconfigurable intelligent surface. Significantly, without an eavesdropper the magnitude of the coupled signal S₂₁ remains under −19 dB for all capacitance values in the varactor tuning range. Simultaneously, the reflection coefficient's magnitude S₁₁ stays above −3 dB. A drop in the magnitudes of the reflected signal and the coupled signal can be indicative of the signal path being compromised by an eavesdropper sniffing part of the signal energy.

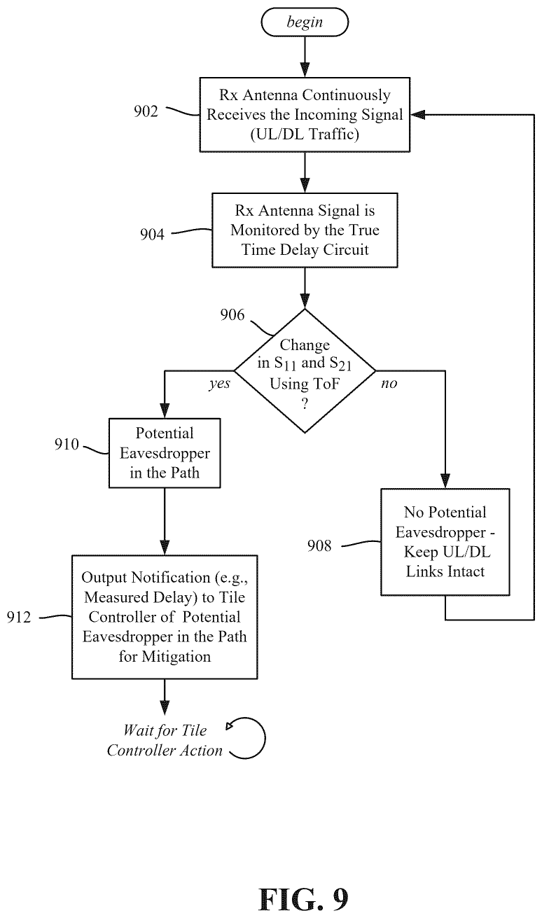

FIG. 9 is a flow diagram showing example operations related to determining whether the signal path is compromised, beginning at operation 902 which represents the Rx antenna continuously receiving the incoming signals for both uplink and downlink (UL/DL) traffic. Operation 904 represents the incoming signals received via the Rx antenna being monitored by the true time delay circuit.

Operation 906 represents evaluating whether there is a change in the S₁₁ and S₂₁ magnitude using time of flight to validate the path integrity/fingerprint the reconfigurable intelligent surface in the path. If no change for a valid path, operation 906 branches to operation 908 which represents the system recognizing that the path integrity is valid/not compromised (no potential eavesdropper is present), whereby the uplink and downlink (UL/DL) path links are kept intact and the monitoring continues.

It should be noted that some relatively small signal strength deviation threshold may be used to allow for some margin of error; for example, weather changes, a brief reflection from a bird, and so on can change the signal strength, but this can be factored into the monitoring. Note that a local tile controller can already have current local environmental state data (e.g., rain, humidity, temperature and the like) and thus expected signal strength and/or expected time of flight can be adjusted based on such current local environmental state data. Indeed, in one implementation, such current local environmental state data can be used as input to a generative adversarial network model or other AI/ML model that evaluates the path integrity and signal strength.

If instead at operation 906 a drop in expected signal strength over an otherwise valid path is detected, operation 906 branches to operation 910 which represents the system recognizing that a potential eavesdropper is present, whereby the uplink and downlink (UL/DL) path links are compromised. Operation 912 represents outputting a notification, (e.g., the measured signal strength change value) to the tile controller/base station and so forth for some type of mitigation, e.g., change polarization, add noise, and so on.

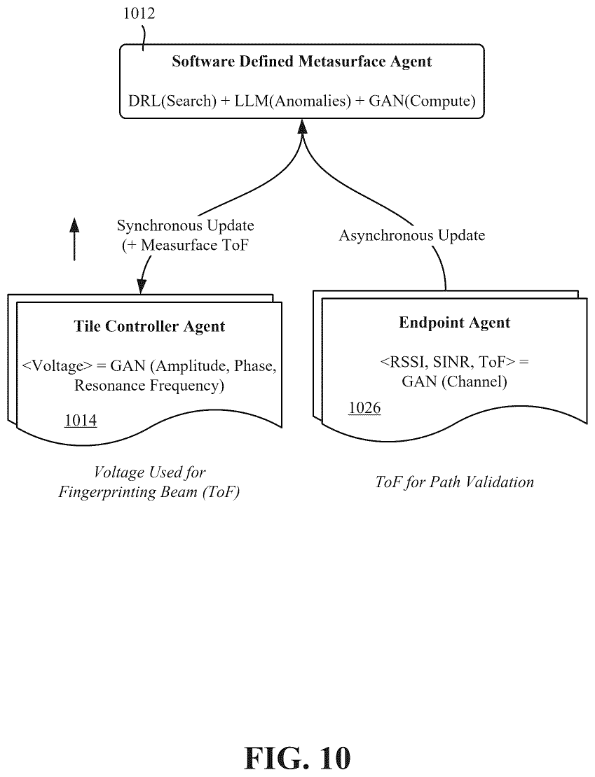

FIG. 10 shows one example implementation of various AI/ML models for inferencing that can be configured and implemented by the various legitimate entities for use in path integrity validation. In general, the tile controller (an agent 1014) runs a generative adversarial network model having a discriminator trained to fingerprint beam data, and in particular, to compute a voltage value based on amplitude, phase, and resonance frequency. These voltage data are fed via (e.g., synchronous sampling) updates to a software defined metasurface agent 1012, which is configured with multiple models.

An endpoint agent 1026, e.g., running on the user equipment, also runs a generative adversarial network model based on channel characteristics for signals. Note that a generative adversarial network model is similar to traditional compute methods, but is mapped into very small footprint suitable for user equipment resources. In general, the endpoint agent's generative adversarial network model captures a vector <RSSI, SINR, ToF> (received signal strength information, signal-plus-interference-to-noise-ratio data, and time of flight data) from the channel characteristics and sends the information via asynchronous updates to the software defined metasurface agent 1012.

In general, the software defined metasurface agent 1012 runs in a controller on the edge cloud or the like, and is therefore centralized from the perspective of base stations and/or tile controllers, which can have wired connections to the edge cloud. In one example implementation, the software defined metasurface agent 1012 includes a deep information learning (DRL) model for path searching, although in this system the location of the reconfigurable intelligent surface is known. A large language model (LLM) is used for macrolevel anomaly detection. A generative adversarial network (GAN) uses the voltage data and the user equipment-provided vector data to evaluate the path integrity and signal strength data, notifying the tile controller if an anomaly is detected.

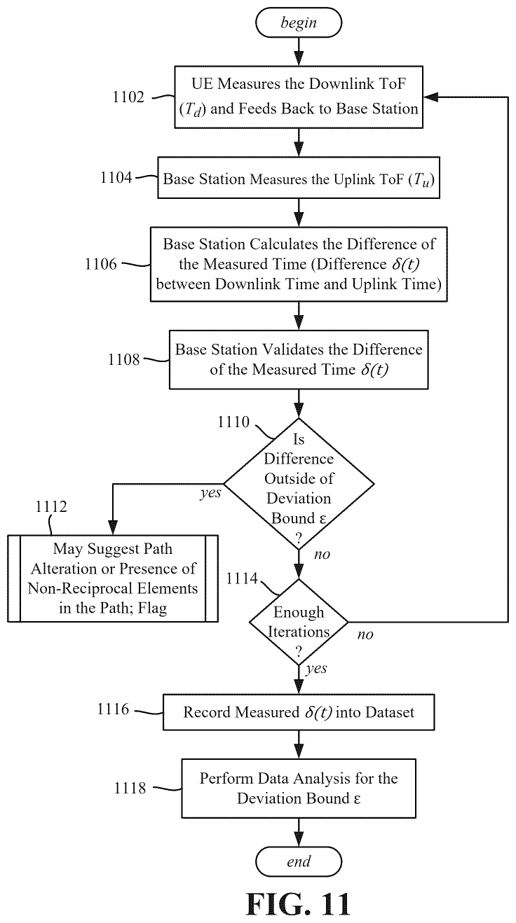

FIG. 11 summarizes various operations related to time-of-flight assisted path validation, beginning at operations 1102 and 1104 which represent obtaining downlink and uplink time measurements, respectively. Operation 1102 represents the UE measuring the downlink time-of-flight (T_{d}), which is measured by the UE as T_{d}=Tₚₐₜₕ+Tᵣᵢₛ_{_{d}}+Tₑₙᵥ, feeding T_{d} back to the base station, where Tₚₐₜₕ denotes the time of flight over the path, Tᵣᵢₛ_{_{d}} denotes the fixed delay for the downlink reflective element of the reconfigurable intelligent surface (RIS), which is only known by the base station, and Tₑₙᵥ denotes the environmental injected delay.

Operation 1104 represents the base station measuring the uplink time-of-flight (Tᵤ), which is measured by base station as T_{d}=Tₚₐₜₕ+Tᵣᵢₛ_{_{d}}+T′ₑₙᵥ, where Tᵣᵢₛ_{ᵤ} denotes the fixed delay for the uplink reflected element of the reconfigurable intelligent surface (RIS), which is also only known by the base station. Note that if the uplink is in the same path as the downlink, the environmental-related delay should be reciprocal, Tₑₙᵥ=T′ₑₙᵥ.

At operation 1106, the base station determines the difference of the measured time. The difference between the downlink time and the uplink time is calculated as:

$$\vert δ ( t ) \vert = \vert {T}_{d} - {T}_{u} \vert = \vert {T}_{{ris}_{d}} - {T}_{{ris}_{u}} \vert .$$

At operation 1108, the base station validates the δ(t) time difference, because only the base station knows about the reconfigurable intelligent surface's fixed delay values of Tᵣᵢₛ_{_{d}} and Tᵣᵢₛ_{ᵤ}, e.g., determined as part of deployment of the reconfigurable intelligent surface. If |T_{d}−Tᵤ|=|δ(t)|+ε, where ε is a deviation bound, then evaluating this equation indicates that path is reciprocal and valid. Deviation from this equality may suggest path alteration(s) or the presence of one or more non-reciprocal elements in the path, which can be flagged via operations 1110 and 1112.

Operations 1114 and 1116 repeat the previous operations for some number of iterations, with the measured data for the iterations and recorded in a dataset. The expected time of flight data is thus known over the signal path for use in evaluating actual time of flight delays for signal path verification. Operation 1118 performs (e.g., via an ML model) data analysis for the deviation bound ε.

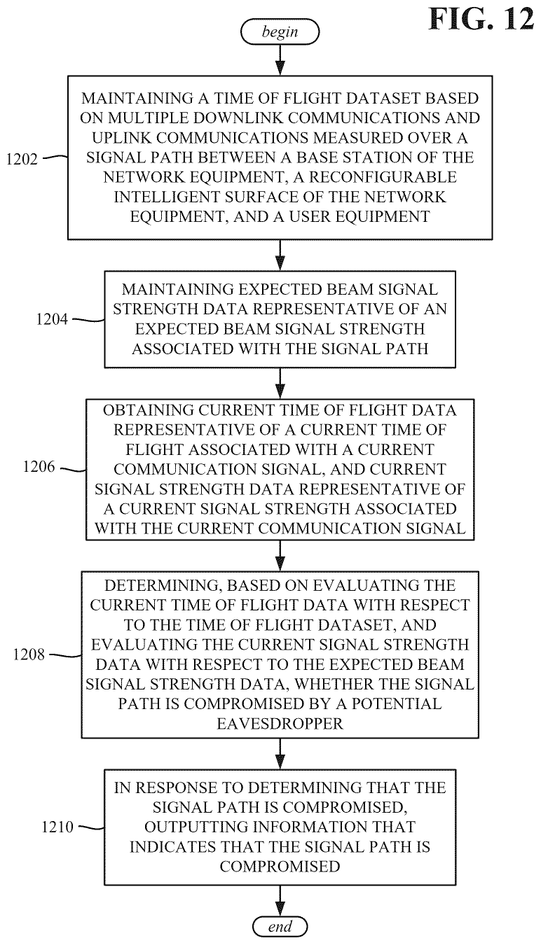

One or more concepts described herein can be embodied in network equipment, such as represented in the example operations of FIG. 12, and for example can include at least one memory that stores computer executable components and/or operations, and at least one processor that executes computer executable components and/or operations stored in the memory. Example operations can include operation 1202, which represents maintaining a time of flight dataset based on multiple downlink communications and uplink communications measured over a signal path between a base station of the network equipment, a reconfigurable intelligent surface of the network equipment, and a user equipment. Example operation 1304 represents maintaining expected beam signal strength data representative of an expected beam signal strength associated with the signal path. Example operation 1306 represents obtaining current time of flight data representative of a current time of flight associated with a current communication signal, and current signal strength data representative of a current signal strength associated with the current communication signal. Example operation 1308 represents determining, based on evaluating the current time of flight data with respect to the time of flight dataset, and evaluating the current signal strength data with respect to the expected beam signal strength data, whether the signal path is compromised by a potential eavesdropper. Example operation 1310 represents, in response to determining that the signal path is compromised, outputting information that indicates that the signal path is compromised.

The current signal strength data can be based on at least one of: an input reflection coefficient or a forward transmission coefficient.

Further operations can include obtaining the current time of flight data from the user equipment based on a vector dataset corresponding to with the current communication signal, the vector dataset comprising received signal strength information representative of a received signal strength associated with the current communication signal, signal-plus-interference-to-noise-ratio data representative of a signal-plus-interference-to-noise-ratio associated with the current communication signal, and a measured time of flight value associated with the current communication signal.

The network equipment can include a software defined metasurface controller, and determining whether the signal path is compromised can be performed by the software defined metasurface controller.

The network equipment can include a software defined metasurface controller, and determining whether the signal path is compromised can be performed by a generative adversarial network that is executed via the software defined metasurface controller.

The network equipment can include a software defined metasurface controller and a tile controller associated with the reconfigurable intelligent surface, and wherein the outputting of the information in response to the determining that the signal path is compromised can include outputting the information that indicates that the signal path is compromised from the software defined metasurface controller to the tile controller.

Further operations can include determining, by a tile controller of the network equipment coupled to the reconfigurable intelligent surface, a voltage value representative of the current signal strength data. The voltage value can be based on at least one of: an input reflection coefficient, or a forward transmission coefficient corresponding to the current communication. The reconfigurable intelligent surface can include a receive antenna that receives the current communication signal, and a detection network, coupled to unit cells of the reconfigurable intelligent surface, that detects at least one of: amplitude data, phase data, or resonance frequency data, for use in the determining of the voltage value.

Determining the voltage value can include inputting parameter data associated with the current communication signal into a generative adversarial network model that is executed via the tile controller; the parameter data can include at least one of: amplitude data representative of an amplitude associated with the current communication signal, phase data representative of a phase associated with the current communication signal, or resonance frequency data representative of a resonance frequency associated with the current communication signal.

The generative adversarial network model can include a first generative adversarial network model, the network equipment can include a software defined metasurface controller via which a second generative adversarial network is executed, determining whether the signal path is compromised can be based on output from the second generative adversarial network; further operations can include obtaining the current time of flight data from the user equipment, via which a third generative adversarial network is executed, based on a vector dataset corresponding to the current communication signal, the vector dataset comprising received signal strength information representative of a received signal strength associated with the current communication signal, signal-plus-interference-to-noise-ratio data representative of a signal-plus-interference-to-noise-ratio associated with the current communication signal, and a measured time of flight value associated with the current communication signal, obtaining the voltage value from the tile controller, and obtaining the output from the second generative adversarial network, comprising inputting the current time of flight data in conjunction with the voltage value to obtain the output from the second generative adversarial network.

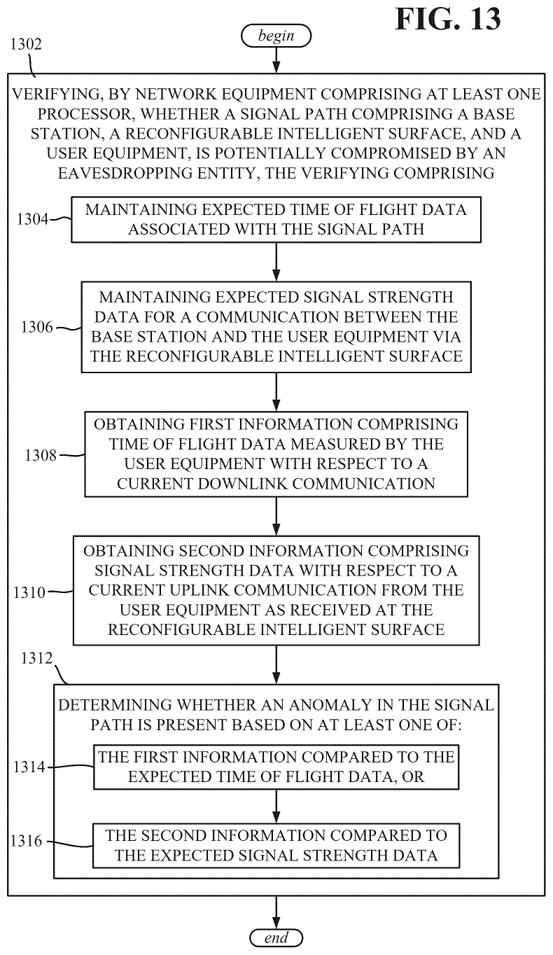

One or more example implementations and embodiments, such as corresponding to example operations of a method, are represented in FIG. 13. Example operation 1302 represents verifying, by network equipment comprising at least one processor, whether a signal path comprising a base station, a reconfigurable intelligent surface, and a user equipment, is potentially compromised by an eavesdropping entity; the verifying can include operations 1304, 1306, 1308, 1310, and 1312. Example operation 1304 represents maintaining expected time of flight data associated with the signal path. Example operation 1306 represents maintaining expected signal strength data for a communication between the base station and the user equipment via the reconfigurable intelligent surface. Example operation 1308 represents obtaining first information comprising time of flight data measured by the user equipment with respect to a current downlink communication. Example operation 1310 represents obtaining second measured data representative of received uplink angle of arrival data for an uplink communication sent by the user equipment via the reconfigurable intelligent surface. Example operation 1312 represents determining whether an anomaly in the signal path is present based on at least one of first information compared to the expected time of flight data (example block 1314), or the second information compared to the expected signal strength data (example block 1316).

The first information can correspond to a first fingerprint representative of the reconfigurable intelligent surface, and obtaining the first information can include receiving a first output result from a first generative adversarial network model that runs on the user equipment based on received signal strength information of the downlink communication, received signal plus interference data of the downlink communication, and time of flight data of the downlink communication.

The second information can correspond to a second fingerprint representative of a beam associated with the uplink communication, the obtaining of the second information can include receiving a second output result from a second generative adversarial network model that runs on a controller coupled to the reconfigurable intelligent surface and the base station, and the second output can be based on amplitude data, phase and resonance frequency of the beam.

Determining whether the anomaly in the signal path is present can include inputting the first information and the second vector dataset into a third generative adversarial network, trained to detect the anomaly, that runs on a metasurface agent coupled to the controller.

Further operations can include, in response to determining that the anomaly in the signal path is present, identifying, by the network equipment, the signal path as potentially compromised to a controller coupled to the reconfigurable intelligent surface and the base station.

Further operations can include obtaining, by the network equipment from the user equipment, respective downlink time of flight values measured for respective downlink communications from the base station to the user equipment via the reconfigurable intelligent surface, measuring, by the base station of the network equipment, respective uplink time of flight values measured for respective uplink communications from the from the user equipment to the base station via the reconfigurable intelligent surface, determining respective difference values between the respective downlink time of flight values and the respective uplink time of flight values, and validating that the respective difference values are within a bound; maintaining the expected time of flight data associated with the signal path can include maintaining a dataset, associated with the reconfigurable intelligent surface, based on the respective downlink time of flight values and the respective uplink time of flight values.

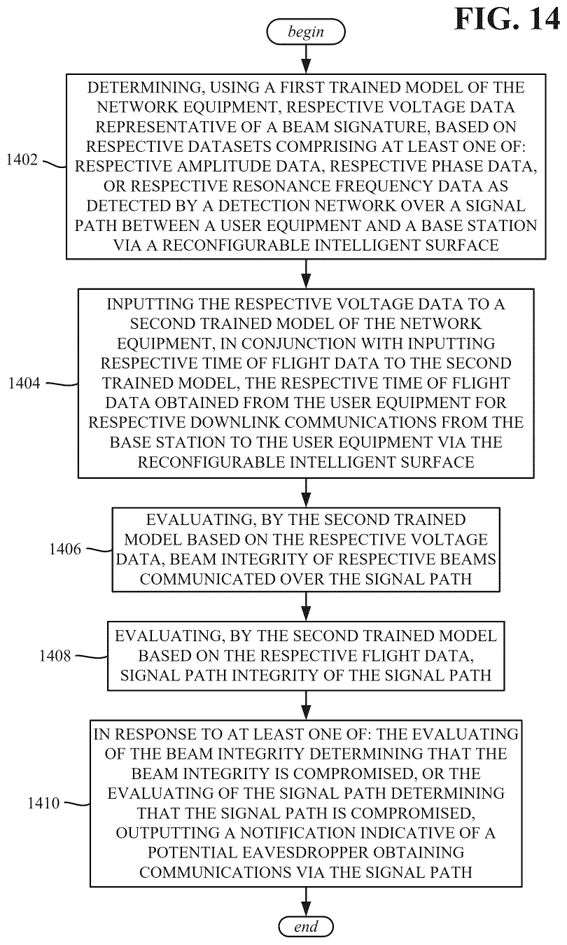

FIG. 14 summarizes various example operations, e.g., corresponding to a machine-readable medium, comprising executable instructions that, when executed by at least one processor of network equipment, facilitate performance of operations. Example operation 1402 represents determining, using a first trained model of the network equipment, respective voltage data representative of a beam signature, based on respective datasets comprising at least one of: respective amplitude data, respective phase data, or respective resonance frequency data as detected by a detection network over a signal path between a user equipment and a base station via a reconfigurable intelligent surface. Example operation 1404 represents inputting the respective voltage data to a second trained model of the network equipment, in conjunction with inputting respective time of flight data to the second trained model, the respective time of flight data obtained from the user equipment for respective downlink communications from the base station to the user equipment via the reconfigurable intelligent surface. Example operation 1406 represents evaluating, by the second trained model based on the respective voltage data, beam integrity of respective beams communicated over the signal path. Example operation 1408 represents evaluating, by the second trained model based on the respective flight data, signal path integrity of the signal path. Example operation 1410 represents, in response to at least one of: the evaluating of the beam integrity determining that the beam integrity is compromised, or the evaluating of the signal path determining that the signal path is compromised, outputting a notification indicative of a potential eavesdropper obtaining communications via the signal path.

Inputting the respective time of flight data obtained from the user equipment can include receiving respective information representative of respective received signal strength information, respective signal-plus-interference-to-noise-ratio data, or respective time of flight measurement values, and inputting the respective information into the second trained model.

Outputting the notification can include outputting the notification from the second trained model to a controller coupled to the reconfigurable intelligent surface.

As can be seen, the technology described herein is directed to full-path validation, including integrating detection circuitry in reconfigurable intelligent surface hardware such that a full-path validation can be made without any significant compute burden. In this way, attackers can be detected when attempting to exploit reconfigurable intelligent surface technology by hijacking and altering communication paths, whereby the technology described herein helps to avoid potential unauthorized access or data interception. Such path manipulation risks emphasize the need for ensuring the integrity of the signal path in reconfigurable intelligent surface-assisted systems.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. Network equipment, comprising:
at least one processor; and
at least one memory that stores executable instructions that, when executed by the at least one processor, facilitate performance of operations, the operations comprising:
maintaining a time of flight dataset based on multiple downlink communications and uplink communications measured over a signal path between a base station of the network equipment, a reconfigurable intelligent surface of the network equipment, and a user equipment;
maintaining expected beam signal strength data representative of an expected beam signal strength associated with the signal path;
obtaining current time of flight data representative of a current time of flight associated with a current communication signal, and current signal strength data representative of a current signal strength associated with the current communication signal;
determining, based on evaluating the current time of flight data with respect to the time of flight dataset, and evaluating the current signal strength data with respect to the expected beam signal strength data, whether the signal path is compromised by a potential eavesdropper; and
in response to determining that the signal path is compromised, outputting information that indicates that the signal path is compromised.

2. The network equipment of claim 1, wherein the current signal strength data is based on at least one of: an input reflection coefficient or a forward transmission coefficient.

3. The network equipment of claim 1, wherein the operations further comprise obtaining the current time of flight data from the user equipment based on a vector dataset corresponding to with the current communication signal, the vector dataset comprising received signal strength information representative of a received signal strength associated with the current communication signal, signal-plus-interference-to-noise-ratio data representative of a signal-plus-interference-to-noise-ratio associated with the current communication signal, and a measured time of flight value associated with the current communication signal.

4. The network equipment of claim 1, wherein the network equipment comprises a software defined metasurface controller, and wherein the determining of whether the signal path is compromised is performed by the software defined metasurface controller.

5. The network equipment of claim 1, wherein the network equipment comprises a software defined metasurface controller, and wherein the determining of whether the signal path is compromised is performed by a generative adversarial network that is executed via the software defined metasurface controller.

6. The network equipment of claim 1, wherein the network equipment comprises a software defined metasurface controller and a tile controller associated with the reconfigurable intelligent surface, and wherein the outputting of the information in response to the determining that the signal path is compromised comprises outputting the information that indicates that the signal path is compromised from the software defined metasurface controller to the tile controller.

7. The network equipment of claim 1, wherein the operations further comprise determining, by a tile controller of the network equipment coupled to the reconfigurable intelligent surface, a voltage value representative of the current signal strength data.

8. The network equipment of claim 7, wherein the voltage value is based on at least one of: an input reflection coefficient, or a forward transmission coefficient corresponding to the current communication.

9. The network equipment of claim 7, wherein the reconfigurable intelligent surface comprises a receive antenna that receives the current communication signal, and a detection network, coupled to unit cells of the reconfigurable intelligent surface, that detects at least one of: amplitude data, phase data, or resonance frequency data, for use in the determining of the voltage value.

10. The network equipment of claim 7, wherein the determining of the voltage value comprises inputting parameter data associated with the current communication signal into a generative adversarial network model that is executed via the tile controller, the parameter data comprising at least one of: amplitude data representative of an amplitude associated with the current communication signal, phase data representative of a phase associated with the current communication signal, or resonance frequency data representative of a resonance frequency associated with the current communication signal.

11. The network equipment of claim 10, wherein the generative adversarial network model comprises a first generative adversarial network model, wherein the network equipment comprises a software defined metasurface controller via which a second generative adversarial network is executed, wherein the determining of whether the signal path is compromised is based on output from the second generative adversarial network, and wherein the operations further comprise:
obtaining the current time of flight data from the user equipment, via which a third generative adversarial network is executed, based on a vector dataset corresponding to the current communication signal, the vector dataset comprising received signal strength information representative of a received signal strength associated with the current communication signal, signal-plus-interference-to-noise-ratio data representative of a signal-plus-interference-to-noise-ratio associated with the current communication signal, and a measured time of flight value associated with the current communication signal,
obtaining the voltage value from the tile controller, and
obtaining the output from the second generative adversarial network, comprising inputting the current time of flight data in conjunction with the voltage value to obtain the output from the second generative adversarial network.

12. A method, comprising
verifying, by network equipment comprising at least one processor, whether a signal path comprising a base station, a reconfigurable intelligent surface, and a user equipment, is potentially compromised by an eavesdropping entity, the verifying comprising:
maintaining expected time of flight data associated with the signal path;
maintaining expected signal strength data for a communication between the base station and the user equipment via the reconfigurable intelligent surface;
obtaining first information comprising time of flight data measured by the user equipment with respect to a current downlink communication;
obtaining second information comprising signal strength data with respect to a current uplink communication from the user equipment as received at the reconfigurable intelligent surface; and
determining whether an anomaly in the signal path is present based on at least one of:
the first information compared to the expected time of flight data, or
the second information compared to the expected signal strength data.

13. The method of claim 12, wherein the first information corresponds to a first fingerprint representative of the reconfigurable intelligent surface, and wherein the obtaining of the first information comprises receiving a first output result from a first generative adversarial network model that runs on the user equipment based on received signal strength information of the downlink communication, received signal plus interference data of the downlink communication, and time of flight data of the downlink communication.

14. The method of claim 13, wherein the second information corresponds to a second fingerprint representative of a beam associated with the uplink communication, wherein the obtaining of the second information comprises receiving a second output result from a second generative adversarial network model that runs on a controller coupled to the reconfigurable intelligent surface and the base station, and wherein the second output is based on amplitude data, phase and resonance frequency of the beam.

15. The method of claim 14, wherein the determining of whether the anomaly in the signal path is present comprises inputting the first information and the second vector dataset into a third generative adversarial network, trained to detect the anomaly, that runs on a metasurface agent coupled to the controller.

16. The method of claim 12, further comprising, in response to determining that the anomaly in the signal path is present, identifying, by the network equipment, the signal path as potentially compromised to a controller coupled to the reconfigurable intelligent surface and the base station.

17. The method of claim 12, further comprising:
obtaining, by the network equipment from the user equipment, respective downlink time of flight values measured for respective downlink communications from the base station to the user equipment via the reconfigurable intelligent surface;
measuring, by the base station of the network equipment, respective uplink time of flight values measured for respective uplink communications from the from the user equipment to the base station via the reconfigurable intelligent surface;
determining respective difference values between the respective downlink time of flight values and the respective uplink time of flight values; and
validating that the respective difference values are within a bound,
wherein the maintaining of the expected time of flight data associated with the signal path comprises maintaining a dataset, associated with the reconfigurable intelligent surface, based on the respective downlink time of flight values and the respective uplink time of flight values.

18. A non-transitory machine-readable medium, comprising executable instructions that, when executed by at least one processor of network equipment, facilitate performance of operations, the operations comprising:
determining, using a first trained model of the network equipment, respective voltage data representative of a beam signature, based on respective datasets comprising at least one of: respective amplitude data, respective phase data, or respective resonance frequency data as detected by a detection network over a signal path between a user equipment and a base station via a reconfigurable intelligent surface;
inputting the respective voltage data to a second trained model of the network equipment, in conjunction with inputting respective time of flight data to the second trained model, the respective time of flight data obtained from the user equipment for respective downlink communications from the base station to the user equipment via the reconfigurable intelligent surface;
evaluating, by the second trained model based on the respective voltage data, beam integrity of respective beams communicated over the signal path;
evaluating, by the second trained model based on the respective flight data, signal path integrity of the signal path; and
in response to at least one of: the evaluating of the beam integrity determining that the beam integrity is compromised, or the evaluating of the signal path determining that the signal path is compromised, outputting a notification indicative of a potential eavesdropper obtaining communications via the signal path.

19. The non-transitory machine-readable medium of claim 18, wherein the inputting of the respective time of flight data obtained from the user equipment comprises receiving respective information representative of respective received signal strength information, respective signal-plus-interference-to-noise-ratio data, or respective time of flight measurement values, and inputting the respective information into the second trained model.

20. The non-transitory machine-readable medium of claim 18, wherein the outputting of the notification comprises outputting the notification from the second trained model to a controller coupled to the reconfigurable intelligent surface.
